(19) United States
(12) Patent Application Publication
(10) Pub. No.: US 2012/0206270 A1
(43) Pub. Date: Aug. 16, 2012

(54) MANHOLE COVER TYPE SENSOR NODE APPARATUS

(75) Inventors: Hyung Su LEE, Seoul (KR); Byung Hun SONG, Namyangju-si (KR); Young Min KWON, Anyang-si (KR)

(73) Assignee: KOREA ELECTRONICS TECHNOLOGY INSTITUTE, Seongnam-si (KR)

(21) Appl. No.: 13/338,974

(22) Filed: Dec. 28, 2011

(30) Foreign Application Priority Data
Feb. 11, 2011 (KR) 10-2011-0012418

(51) Int. Cl. G08C 15/06

(52) U.S. Cl. 340/870.02

(57) ABSTRACT

A manhole cover type sensor node apparatus combined with a manhole cover includes a first antenna located on one side of the manhole cover, a second antenna located on the other side of the manhole cover, and a node combined with the manhole cover and configured to control transmission and reception of data through the first antenna and the second antenna. The node controls reception of flow rate data from a flowmeter supporting radio communication through the first antenna and transmission of the flow rate data to a flow rate data collecting device through the second antenna.

### CROSS-REFERENCE TO RELATED APPLICATION

This application claims priority to and the benefit of Korean Patent Application No. 10-2011-0012418 filed in the Korean Intellectual Property Office on Feb. 11, 2011, the entire contents of which are incorporated herein by reference.

### BACKGROUND OF THE INVENTION

(a) Field of the Invention

The present invention relates to a manhole cover type sensor node apparatus.

(b) Description of the Related Art

A flowmeter is an apparatus which measures a flow rate of a fluid flowing in a pipe. Flow rate data acquired by the flowmeter is transmitted to an external flowmeter controller connected to the flowmeter via a wire. An electronic ultrasonic flowmeter and an electronic flowmeter are typical flowmeters, and an electronic battery flowmeter employing wireless technology has been recently developed. A radio communication based flowmeter does not require additional expenses for power and communication wiring. When the radio communication based flowmeter is installed, an apparatus for transmitting radio data to the outside of a flowmeter room is needed. To implement this apparatus, an antenna can be attached to the outer wall of the flowmeter room to transmit radio data. However, this requires an additional construction work. Furthermore, since the flowmeter room is usually located under a pedestrian road, it is difficult to set a protruded apparatus.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a manhole cover type sensor node apparatus having advantages of communicating with a radio communication based flowmeter and wirelessly communicating with a flowmeter controller located outside a flowmeter room to wirelessly receive flow rate data in consideration of a flowmeter room installation environment.

An exemplary embodiment of the present invention provides a manhole cover type sensor node apparatus including a first antenna located on one side of the manhole cover, a second antenna located on the other side of the manhole cover, and a node combined with the manhole cover and configured to control transmission and reception of data through the first antenna and the second antenna.

The node may include a first communication module connected to the first antenna and configured to process transmitted/received data based on a first radio communication scheme, a second communication module connected to the second antenna and configured to process transmitted/received data based on a second radio communication scheme, and a controller connected to the first communication module and the second communication module to control transmission and reception of data.

The node may control reception of flow rate data from a flowmeter supporting radio communication through the first antenna and transmission of the flow rate data to a flowmeter controller through the second antenna.

The manhole cover type sensor node apparatus may further include an acceleration sensor for sensing the movement of the manhole cover.

Another exemplary embodiment of the present invention provides a manhole cover type sensor node apparatus including a manhole cover part covering a manhole located at the boundary of the inside and outside of a flowmeter room, a first antenna attached to the manhole cover part and receiving data from a radio communication based flowmeter located inside the flowmeter room, a second antenna attached to the manhole cover part and transmitting data to the outside of the flowmeter room, and a node configured to control transmission and reception of data through the first antenna and the second antenna.

The manhole cover part may have a solar cell panel attached thereto.

In accordance with an exemplary embodiment of the present invention, there is no need to install an additional antenna for radio communication at the outer wall of the flowmeter room because the manhole cover type sensor node apparatus installed in the flowmeter room is used. In addition, when the manhole cover type sensor node apparatus is used, it is possible to easily acquire flow rate data by receiving the flow rate data through a radio terminal outside the flowmeter room and measuring and inspecting the flow rate data and to overcome a problem of restriction on the location of the flowmeter controller over a wired flowmeter.

### BRIEF DESCRIPTION OF THE DRAWINGS

FIG. 1 is a cross-sectional view of a flowmeter room in which a manhole cover type sensor node apparatus according to an exemplary embodiment of the present invention is installed;

FIGS. 2A, 2B, 2C and 2D illustrate an exemplary manhole cover type sensor node apparatus according to an exemplary embodiment of the present invention; and

FIG. 3 is a block diagram of the manhole cover type sensor node apparatus according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising”, will be understood to imply the inclusion of stated elements but not the exclusion of any other elements.

A manhole cover type sensor node apparatus according to an exemplary embodiment of the present invention will be described in detail with reference to the attached drawings.

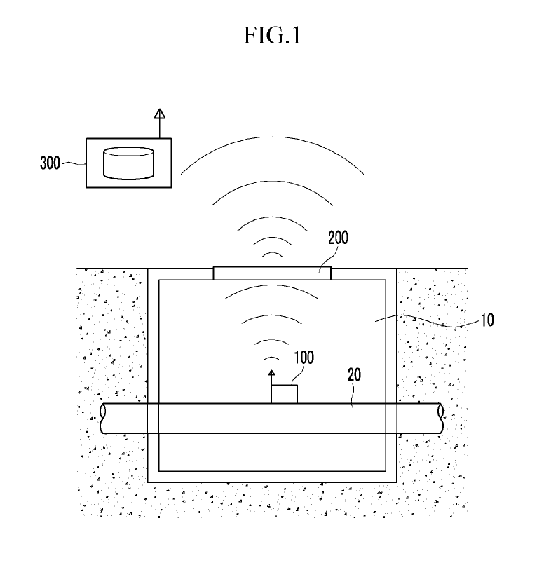

FIG. 1 is a cross-sectional view of a flowmeter room 10 in which a manhole cover type sensor node apparatus according to an exemplary embodiment of the present invention is installed.

Referring to FIG. 1, a pipe 20 in which a fluid flows and a flowmeter 100 for measuring a flow rate of the fluid flowing in the pipe 20 are installed in the flowmeter room 10 which can be located under the ground in which the pipe 20 is laid. The flowmeter room 10 is connected with the outside through a manhole covered with a manhole cover 200. The manhole cover 200 is a device combined with a communication device supporting radio communication, and is defined as a manhole cover type sensor node apparatus to be distinguished from the conventional manhole cover. The flowmeter 100 is a radio communication based flowmeter which transmits flow rate data to the manhole cover type sensor node device 200 using a radio communication scheme, and the manhole cover type sensor node apparatus 200 sends the received data to a flowmeter controller 300 located outside the flowmeter room 10.

The flowmeter 100 measures a flow rate of a fluid flowing in the pipe, includes a radio communication module, and transmits acquired data in a wireless scheme.

The manhole cover type sensor node apparatus 200 transmits data received from the radio communication based flowmeter 100 to the flowmeter controller 300 through antennas respectively attached to the inner side of the apparatus 200, which faces the inside of the flowmeter room 10, and the outer side thereof, which faces the outside. At this time, the manhole cover type sensor node apparatus 200 can operate as a repeater which retransmits received data. The manhole cover type sensor node apparatus 200 can separate communication with the flowmeter 100 which is an underground device from communication with the flowmeter controller 300 which is a ground device and apply to the flowmeter 100 and the flowmeter controller 300 wireless communication schemes respectively suitable for environmental characteristics of the flowmeter 100 and the flowmeter controller 300. Particularly, the manhole cover type sensor node apparatus 200 serves as a ubiquitous sensor network (USN) such that a variety of USN technologies can be applied thereto. The USN, a network including a plurality of sensor nodes, supports unrestricted utilization of data, collected from sensor nodes located at various places and processed, any time any place. For example, the manhole cover type sensor node apparatus 200 can provide an underground facility positioning service using a chirp spread spectrum (CSS) communication scheme, one of USN location technologies. When the manhole cover type sensor node apparatus 200 includes an acceleration sensor, a main agent of facility management can prevent robbery by monitoring the movement of the manhole cover type sensor node apparatus 200. In addition, the manhole cover type sensor node apparatus 200 can transmit a control signal received from a device on the ground, for example, the flowmeter controller 300, to an underground device, for example, the flowmeter 100, such that the flowmeter controller 300 controls the flowmeter 100.

The flowmeter controller 300 which controls the flowmeter 100 and receives flow rate data may be a wireless mobile terminal not a fixed device.

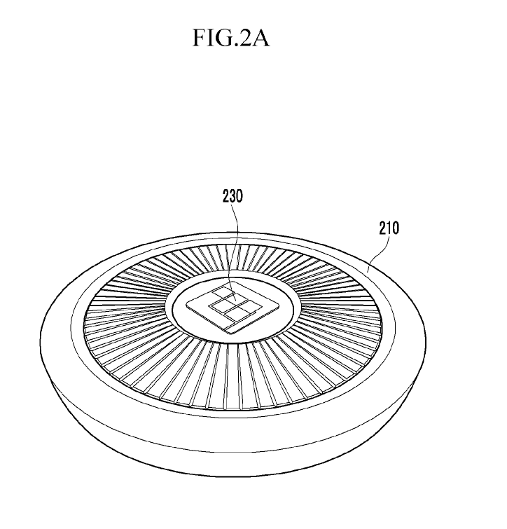

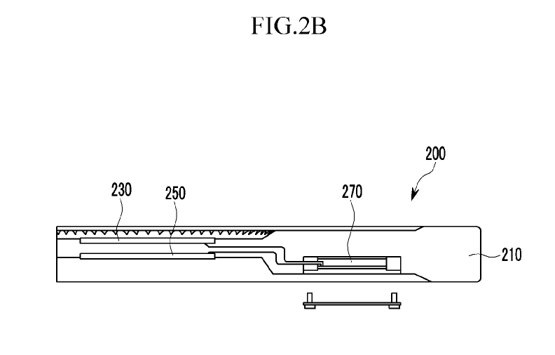

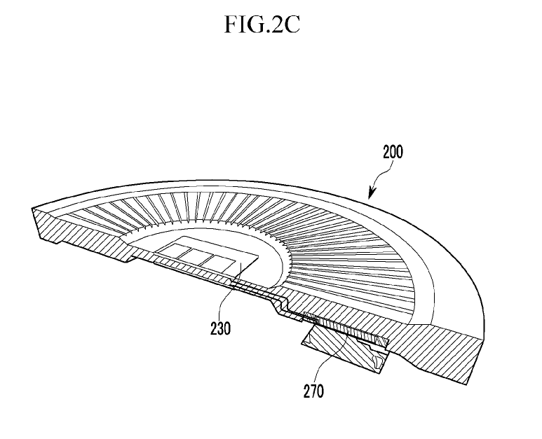

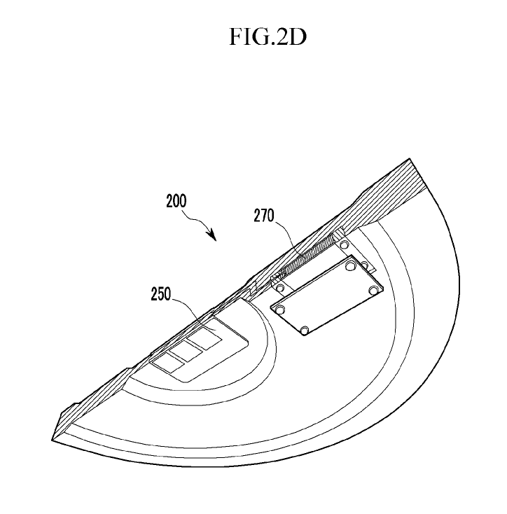

FIGS. 2A, 2B, 2C and 2D illustrate an exemplary manhole cover type sensor node apparatus according to an exemplary embodiment of the present invention. FIG. 2A is a perspective view of the manhole cover type sensor node apparatus, and FIGS. 2B, 2C and 2D are cross-sectional views of the manhole cover type sensor node apparatus.

Referring to FIG. 2A, the manhole cover type sensor node apparatus 200 includes a manhole cover part 210 in the form of a manhole cover and an antenna 230 for radio communication. The manhole cover part 210 can include a solar cell panel attached thereto. The antenna 230 may be a patch antenna attached to the manhole cover part 210, for example, a patch type array antenna.

Referring to FIGS. 2B, 2C and 2D, the manhole cover type sensor node apparatus 200 includes the manhole cover part 210, the antenna 230 communicating with a device located above, an antenna 250 communicating with a device located therebelow, and a node 270 connected to the antennas 230 and 250. The antennas 230 and 250 may be patch antennas. The manhole cover type sensor node apparatus 200 can differentiate a radio communication scheme using the antenna 230 from a radio communication scheme using the antenna 250 to use wireless schemes in consideration of both ground and underground environment characteristics. For example, the node 270 includes a communication module compatible with a device which transmits/receives data to/from the manhole cover type sensor node apparatus 200, a communication module communicating with a ground device, and a communication module communicating with an underground device. Here, the communication modules may employ one of Zigbee communication scheme and CSS communication scheme.

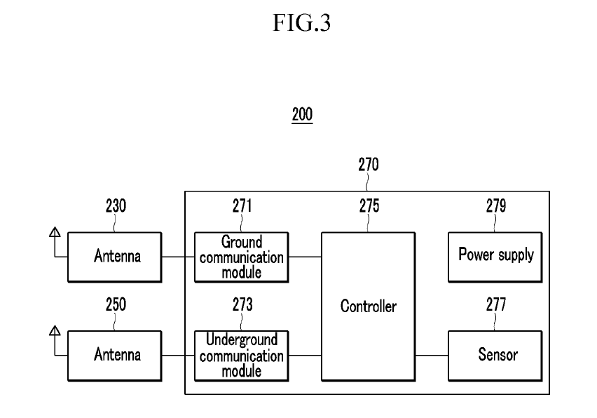

FIG. 3 is a block diagram of the manhole cover type sensor node apparatus 200 according to an exemplary embodiment of the present invention.

Referring to FIG. 3, the manhole cover type sensor node apparatus 200 includes the antennas 230 and 250 respectively attached to both sides of the manhole cover part 210, and a node 270 connected to the antennas 230 and 250. The node 270 includes a ground communication module 271 connected to the antenna 230, an underground communication module 273 connected to the antenna 250, a controller 275 connected to the ground communication module 271 and the underground communication module 273, a sensor 277, and a power supply 279.

The antenna 230 communicates with a device located above the manhole cover part 210 and the antenna 250 communicates with a device located under the man hole cover part 210. For example, the antenna 230 communicates with the flowmeter controller 300 which is a ground device and the antenna 250 communicates with the radio communication based flowmeter 100 which is an underground device.

The node 270 controls transmission and reception of data through the antennas 230 and 250 and includes the ground communication module 271, the underground communication module 273, the controller 275, the sensor 277, and the power supply 279.

The ground communication module 271 is connected to the antenna 230 facing the ground and employs a communication scheme compatible with the ground device which transmits/receives data. The underground communication module 273 is connected to the antenna 250 facing the underground and employs a communication scheme compatible with the underground device which transmits/receives data. For example, the ground communication module 271 and the underground communication module 273 can employ one of Zigbee communication scheme and CSS communication scheme.

The controller 275 is a micro control unit (MCU) which is connected to the ground communication module 271 and the underground communication module 273 to control transmission and reception of data. For example, the controller 275 can control reception of flow rate data from the flowmeter 100 supporting a radio communication through the antenna 250 and transmission of the flow rate data to the flowmeter controller 300 which collects flow rate data through the antenna 230. Further, the controller 275 can control a control signal received from the flowmeter controller 300 to be transmitted to the flowmeter 100. The controller 275 can be implemented as a chip in which the ground communication module 271 and the underground communication module 273 are integrated.

The sensor 277 may be a multi-purpose sensor. For example, the sensor 277 can be an acceleration sensor.

The power supply 279 supplies power to the manhole cover type sensor node apparatus 200. The power supply 279 may be a battery. Otherwise, the power supply 297 can harvest solar energy acquired from a solar cell panel attached to the manhole cover part 210 to supply power.

As described above, when the manhole cover type sensor node apparatus 200 is installed in a manhole, flow rate data measured by the radio communication based flowmeter 100 installed under the ground such as the flowmeter room 10 can be efficiently transmitted to the flowmeter controller 300 on the ground. Particularly, since the manhole cover type sensor node apparatus 200 includes antennas, there is no need to install an additional antenna for radio communication at the outer wall of the flowmeter room 10. Furthermore, since the manhole cover type sensor node apparatus 200 serves as a repeater which retransmits data, the flowmeter controller 300 can measure and control data outside the flowmeter room 10. In addition, the manhole cover type sensor node apparatus can be a mobile device such as a mobile terminal and thus its installation location is less restricted.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A manhole cover type sensor node apparatus combined with a manhole cover comprising:
a first antenna located on one side of the manhole cover;
a second antenna located on the other side of the manhole cover; and
a node combined with the manhole cover and configured to control transmission and reception of data through the first antenna and the second antenna.

2. The manhole cover type sensor node apparatus of claim 1, wherein the node comprises:
a first communication module connected to the first antenna and configured to process transmitted/received data based on a first radio communication scheme;
a second communication module connected to the second antenna and configured to process transmitted/received data based on a second radio communication scheme; and
a controller connected to the first communication module and the second communication module to control transmission and reception of data.

3. The manhole cover type sensor node apparatus of claim 1, wherein the node controls reception of flow rate data from a flowmeter supporting radio communication through the first antenna and transmission of the flow rate data to a flowmeter controller through the second antenna.

4. The manhole cover type sensor node apparatus of claim 1, further comprising an acceleration sensor for sensing the movement of the manhole cover.

5. A manhole cover type sensor node apparatus comprising:
a manhole cover part covering a manhole located at the boundary of the inside and outside of a flowmeter room;
a first antenna attached to the manhole cover part and receiving data from a radio communication based flowmeter located inside the flowmeter room;
a second antenna attached to the manhole cover part and transmitting data to the outside of the flowmeter room; and
a node configured to control transmission and reception of data through the first antenna and the second antenna.

6. The manhole cover type sensor node apparatus of claim 5, wherein the manhole cover part has a solar cell panel attached thereto.
